(19) United States
(12) Patent Application Publication
(10) Pub. No.: US 2015/0333317 A1
(43) Pub. Date: Nov. 19, 2015

(54) STRUCTURE OF COMPLEXED CATHODE USING Li2S

(71) Applicant: HYUNDAI MOTOR COMPANY, Seoul (KR)

(72) Inventors: Ho Taek LEE, Seoul (KR); Sam Ick SON, Suwon-si (KR)

(21) Appl. No.: 14/559,838

(22) Filed: Dec. 3, 2014

(30) Foreign Application Priority Data
May 15, 2014 (KR) 10-2014-0058631

(51) Int. Cl. H01M 4/1397; H01M 4/04; H01M 4/136; H01M 4/58; H01M 4/62

(52) U.S. Cl. CPC H01M 4/1397; H01M 4/5815; H01M 4/622; H01M 4/625; H01M 4/136; H01M 4/0404; H01M 2004/028

(57) ABSTRACT

A method for manufacturing a cathode of a lithium-sulfur secondary battery includes powder-complexing of Li₂S as a mother particle and a conducting material as a daughter particle. The powder complexed and a binder are mixed in a solvent to form a mixture, additional conducting material is added to the mixture, and then the mixture is further mixed. The mixture is placed in a ball mill and then mixed for 0.2-24 hours in the ball mill to obtain a slurry. The slurry is coated on a collector to a thickness of 0.005-0.2 mm. The coated slurry is dried with hot air at a temperature higher than ambient.

### CROSS-REFERENCE TO RELATED APPLICATION

This application claims under 35 U.S.C. §119(a) the benefit of priority to Korean Patent Application No. 10-2014-0058631 filed on May 15, 2014, the entire contents of which are incorporated herein by reference.

### TECHNICAL FIELD

The present disclosure relates to a cathode structure covered with Li₂S powder. More particularly, the present disclosure relates to a cathode structure covered with Li₂S powder complexed with a conducting material capable of maintaining structure of an active material in the volume expansion state, thus improving life time of a lithium-sulfur battery by preventing collapse of the cathode structure caused by volume expansion after repeated charge/discharge cycles.

### BACKGROUND

In general, a sulfur cathode is solid sulfur in a fully charged state and is Li₂S in a discharged state. The volume of the Li₂S is equivalent to 180% volume of sulfur. A cathode structure of a lithium-sulfur battery collapses by volume expansion and contraction, which are caused by repeated charge and discharge. The conventional lithium-sulfur battery uses sulfur powder as an active material of a cathode.

An electrode was formed by mixing the sulfur as an active material, a conducting material for giving conductivity thereto and a binder for maintaining structural integrity in a solvent to obtain a slurry, and coating the slurry on a collector. However, when the sulfur starts to be discharged, it is converted to Li₂S via lithium polysulfide, and as a result, the volume expands by 80%, and the electrode structure collapses because of this expansion.

US Patent Publication No. 2012/0094189A1 (Scrosati et al.) discloses a lithium-sulfur polymer battery, wherein an electrolyte is fixed to a polymer matrix and an electrode is manufactured with a Li₂S-carbon composite. However, Scrosati et al. is limited to batteries using the polymer matrix, and therefore, does not limit the scope of the present disclosure, which prevents collapse of the structure in a general lithium-sulfur battery caused by volume expansion.

US Patent Publication No. 2013-0164625 discloses a cathode having a carbon-sulfur core-shell structure for preventing a reduction of charge/discharge efficiency and electrical cut-off by an irreversible barrier, caused by Li₂S produced during charging/discharging cycles of a lithium-sulfur battery. However, the process control is very difficult due to a very sensitive sulfur deposition process. A sulfur-based ion and a carbon source were acid-treated in an aqueous solution so as to combine the sulfur-based ion as a nucleus on the carbon surface. Further, a network having electrical conductivity was formed, and at this time, the nucleated sulfur and carbon were chemically bonded.

US Patent Publication No. 2013-0224594 discloses a battery cathode electrode composition comprising core-shell composites, wherein each of the composites may comprise a sulfur-based core and a multi-functional shell. The sulfur-based core is provided to electrochemically react with metal ions during battery operation to store the metal ions in the form of a corresponding metal-sulfide during discharging or charging of the battery and to release the metal ions from the corresponding metal-sulfide during charging or discharging of the battery. The multi-functional shell partially encases the sulfur-based core and is formed from a material that is (i) substantially permeable to the metal ions of the corresponding metal-sulfide and (ii) substantially impermeable to electrolyte solvent molecules and metal polysulfides.

Korean Patent Publication No. 10-2006-0130964 discloses a cathode active material for a lithium secondary battery having a core-shell multi-layer structure. In a cathode active material for a lithium secondary battery, the core part consists of Li₁₊ₐMn₂₋ₐO_{4-y}A_{y} (A is at least one element of F and S, 0.04≦a≦0.15, 0.02≦y≦0.15), and shell part consists of Li[Liₐ(Mn₁₋ₓMₓ)₁₋ₐ]2O_{4-y}A_{y} (M is at least one element selected from the group consisting of Fe, Co, Ni, Cu, Cr, V, Ti, and Zn, A is at least one element of F or S, 0.01≦a≦0.333, 0.01≦x≦0.6, 0.02≦y≦0.15).

Korean Patent Publication No. 10-2010-0085941 discloses a nanoparticle having a core comprised of a first material and a layer comprised of a second material. One of the first and second materials is a semiconductor material incorporating ions from group 13 and group 15 of the periodic table and the other of the first and second materials is a metal oxide material incorporating metal ions selected from any one of groups 1 to 12, 14, and 15 of the periodic table.

However, any of techniques described above dose not fundamentally solve the cathode structure collapse according to volume expansion and contraction during repeated charging/discharging cycles.

The above information disclosed in this Background section is only for enhancement of understanding of the background of the invention, and therefore, it may contain information that does not form the prior art that is already known in this country to a person of ordinary skill in the art.

### SUMMARY OF THE DISCLOSURE

The present invention has been made in an effort to solve the above-described problems associated with prior art. The present disclosure improves life time of a lithium-sulfur battery.

A sulfur cathode is solid in a fully charged state, and is Li₂S in a discharged state. The volume of the Li₂S is equivalent to 180% of the volume of the sulfur. The cathode structure of the lithium-sulfur battery collapses by volume expansion and contraction caused by repeated charge and discharge (see FIG. 3).

An aspect of the present disclosure provides a cathode structure covered with Li₂S powder complexed with a conducting material in order to improve the life time of a lithium-sulfur battery (see FIG. 4). Because this structure maintains the structure of an active material in the volume expansion state, the life time of the lithium-sulfur battery may be improved by preventing collapse of the cathode structure caused by volume expansion after repeated charge/discharge cycles.

According to an exemplary embodiment of the present invention, a method for manufacturing a cathode of a lithium-sulfur secondary battery includes power-complexing of Li₂S as a mother particle and a conducting material as a daughter particle. The powder complexed and a binder are mixed in a solvent to form a mixture, additional conducting material is added to the mixture, and then further mixing the mixture. The mixture is placed in a ball mill and then mixed for 0.2-24 hours in the ball mill to obtain a slurry. The slurry is coated on a collector to a thickness of 0.005-0.2 mm. The coated slurry is dried with hot air at a temperature higher than ambient.

The conducting material may be a carbon material.

The carbon material may be a carbon nanotube (CNT), acetylene black, vapor grown carbon fiber (VGCF), or a mixture of at least two thereof.

The binder may be nitrile butadiene bubber (NBR), styrene butadiene rubber (SBR), or a mixture thereof.

The solvent may be an aromatic solvent selected from toluene, xylene, benzene, C₆-C₂₀ aliphatic solvent, or a mixture of at least two thereof.

The collector may be Al at the cathode and Cu at the anode.

The powder complexing may be conducted through a mechanofusion process.

An average diameter of the Li₂S to be powder complexed may be 10 times or greater of an average diameter of the conducting material.

An average particle size of the daughter particle may be 1/10 or less of an average particle size of the mother particle.

The content of the daughter particle to be powder complexed (1/(a+1)) may be determined by the following Formulas 1 to 3:

Formula 1

When the number of the daughter particle, which is required for 100% covering a surface of the mother particle having a radius of x and the daughter particle having a radius of r, is designated as X,

$$π {r}^{2} X = 4 {π ( x + 2 r )}^{2}$$

$$X = \frac{4 {( x + r )}^{2}}{{r}^{2}}$$

Formula 2

A weight of the number of carbon powder X of the complexed powder having a density

$$( d ) = d \frac{4}{3} π {r}^{3} \frac{4 {( x + r )}^{2}}{{r}^{2}} = \frac{16}{3} d π {r ( x + r )}^{2}$$

Formula 3

A weight of the mother particle/a weight of the daughter particle=a=

$$\frac{\frac{4}{3} π {x}^{3} \times 1.66}{\frac{16}{3} d π {r ( x + r )}^{2}} = \frac{1.66 {x}^{3}}{4 d {r ( x + r )}^{2}}$$

Other aspects and embodiments of the invention are discussed infra.

### BRIEF DESCRIPTION OF THE DRAWINGS

The above and other features of the present invention will now be described in detail with reference to certain exemplary embodiments thereof illustrated by the accompanying drawings which are given hereinbelow by way of illustration only, and thus are not limitative of the present invention.

FIG. 1 is a diagram showing a mechanofusion process.

FIG. 2 is photographs of complexed Li₂S powder.

FIG. 3 is a diagram showing a process of structure collapse of lithium-sulfur battery cathode material by volume expansion and contraction according to repeated charge/discharge.

FIG. 4 is a diagram showing a process in the case of manufacturing an electrode using Li₂S as a cathode material of the present disclosure, life time characteristic improvement by reduced structure modification of a surface-treated carbon layer without volume expansion, compared to the initial structure.

FIG. 5 is a diagram visually showing different particle diameters.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

The present disclosure provides a method for manufacturing a cathode of a lithium-sulfur secondary battery comprising the following steps:
1) powder-complexing of Li₂S as a mother particle and a conducting material as a daughter particle;
2) mixing the powder complexed in step 1) and a binder in a solvent to form a mixture, adding additional conducting material to the mixture and then further mixing the mixture;
3) placing the mixture of step 2) in a ball mill and then mixing thereof for 0.2-24 hours to obtain a slurry;
4) coating the slurry of step 3) on a collector to a thickness of 0.005-0.2 mm; and
5) drying the coated slurry of step 4) with hot air at a temperature higher than ambient.

In step 1), a method of the powder complexing is as follows.

Crushed Li₂S powder and the conducting material are filled into a dry-type complexing device. The size of a carbon material as the daughter particle is 1/10 or less of the average particle size of the Li₂S as the mother particle. If the average particle size of the daughter particle is larger than 1/10 of that of the mother particle, the daughter particle may not effectively cover the mother particle. A fibrous long material is determined on the basis of a diameter. Weight ratio of the Li₂S and the carbon material is calculated in consideration of density of the materials and degree of surface coverage. The required minimum carbon material content is calculated by Formulas 1 to 3. This means that at least the amount of the carbon material is used to construct at least one layer of the carbon material on the outer wall of the Li₂S particle. Shearing force of the dry-type complexing device is controlled to be 200-400 W, and the powder complexing is conducted for 4-20 min.

Formula 1

When the number of the carbon powder required for 100% covering the surface of the Li₂S having a radius of x and the carbon material having a radius of r is designated as X,

$$π {r}^{2} X = 4 {π ( x + 2 r )}^{2}$$

$$X = \frac{4 {( x + r )}^{2}}{{r}^{2}}$$

Formula 2

Weight of X of the complexed powder having density

$$( d ) = d \frac{4}{3} π {r}^{3} \frac{4 {( x + r )}^{2}}{{r}^{2}} = \frac{16}{3} d π {r ( x + r )}^{2}$$

Formula 3

Li₂S/carbon material (weight ratio)

$$\frac{\frac{4}{3} π {x}^{3} \times 1.66}{\frac{16}{3} d π {r ( x + r )}^{2}} = \frac{1.66 {x}^{3}}{4 d {r ( x + r )}^{2}}$$

When the weight ratio is a, the content of the carbon material, which is the daughter particle in the entire powder, is 1/(a+1). This value is calculated and the result is shown in Table 4, which is the minimum weight ratio of the carbon for constructing at least one layer of the carbon material on the outer wall of the Li₂S, and complexing would be possible when the at least amount is used.

TABLE 4

| | carbon material size | | | | | |
|---|---|---|---|---|---|---|
| Li₂S size | 3 μm | 5 μm | 10 μm | 20 μm | 30 μm | 40 μm |
| 0.01 μm | 1.6% | 1.0% | 0.5% | 0.2% | 0.2% | 0.1% |
| 0.02 μm | 3.2% | 1.9% | 1.0% | 0.5% | 0.3% | 0.2% |
| 0.03 μm | 4.7% | 2.8% | 1.4% | 0.7% | 0.5% | 0.4% |
| 0.04 μm | 6.2% | 3.8% | 1.9% | 1.0% | 0.6% | 0.5% |
| 0.05 μm | 7.7% | 4.7% | 2.4% | 1.2% | 0.8% | 0.6% |
| 0.1 μm | 14.6% | 9.1% | 4.7% | 2.4% | 1.6% | 1.2% |
| 0.15 μm | 21.0% | 13.3% | 6.9% | 3.5% | 2.4% | 1.8% |
| 0.2 μm | 26.8% | 17.3% | 9.1% | 4.7% | 3.2% | 2.4% |

In step 3), the mixture is mixed for 0.2-24 hours to obtain the slurry. If the time is shorter than this range, mixing is not sufficient, and if the time is longer than this range, the complexed powder and the binder can be destroyed.

The conducting material may be a carbon material, and the carbon material may be a carbon nanotube (CNT), acetylene black, vapor grown carbon fiber (VGCF), or a mixture of at least two thereof.

The binder may be a nitrile butadiene rubber (NBR), a styrene butadiene rubber (SBR), or a mixture of at least two thereof.

The solvent may be mainly an aromatic solvent such as toluene, xylene, benzene, C₆-C₂₀ aliphatic solvent, or a mixture of at least two thereof. This solvent is used to stably maintain the Li₂S particle without the Li₂S particle being dissolved in the solvent, and the binder is used since it is effective in the combination of the solvent, the Li₂S, and the conducting material.

The collector may be Al.

The powder complexing may be conducted through a mechanofusion process. The average diameter of the Li₂S to be powder complexed may be 10 times or greater of the average diameter of the conducting material.

In manufacturing the sulfur cathode by the disclosed method, the sulfur material forms a shell structure which fits the fully expanded Li₂S core, thereby a cathode whose structure is stably maintained without structure collapse, even if charge and discharge are repeated, may be provided.

As a method for forming a core/shell structure, a powder complexing method is applied, and more specifically, the mechanofusion process may be applied. The powder complexing technique forms the core/shell structure by covering the Li₂S surface with the conducting material, and if the surface is treated with fibrous carbon, an effective conduction network can be formed, and an active material can be stably maintained inside of the core.

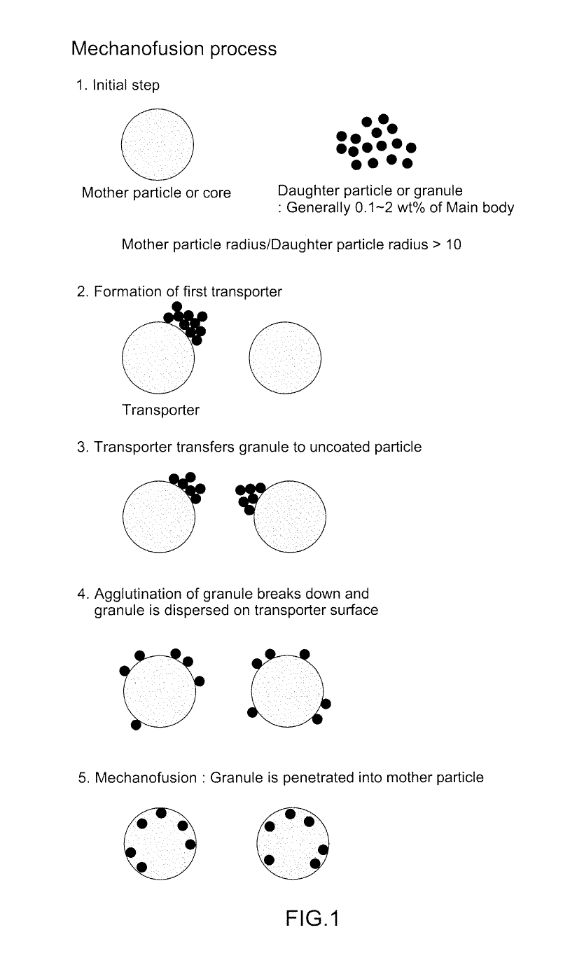

As the powder complexing technique for forming the core/shell structure, the mechanofusion technique can control powder shape by adding a compressive force and a shearing force, and can manufacture mechanical alloy, surface modification and a powder having a multi-layered structure by surface bonding between heterogeneous materials. If the average particle size of the daughter particle is 1/10 or less of the average size of the mother particle, the mechanofusion technique can be applied regardless of material density. The reaction mechanism of the mechanofusion may be explained by FIG. 1 and the following steps. Step 1 mixes the mother particle and the daughter particle. In general, the size of the daughter particle is 1/10 or less of size of the mother particle. Step 2 adheres daughter particle groups to the surface of the mother particle, and the daughter particles clustered by shearing force non-uniformly coat the surface of the mother particle. Step 3 transfers the daughter particles group between the mother particles by exchanging the shearing force between the mother particles. Step 4 is a coating step, wherein the daughter particle groups are degraded on the surface of the mother particle, and the surface of the mother particle is evenly coated. Step 5 is a step wherein the daughter particles are inserted inside of the mother particle as bonding forces between the daughter particle and the mother particle increases when the complexing time increases.

The shearing force applied to the powder may be determined according to a particle size difference between the mother particle and the daughter particle, volume ratio of the mother particle and the daughter particle, the total powder filling quantity, and rotor gap and rotor RPM of a device, and the powder complexing is conducted by controlling the complexing treating time. In order to remove friction heat generated during the powder treatment, the exterior of the device is protected with a water cooling jacket.

### EXAMPLES

Hereinafter, the present disclosure will be described in detail with reference to Examples and the accompanying drawings. The following examples illustrate the method for manufacturing a sulfur cathode and are not intended to limit the same.

### Example 1 to 5

### Complexation of Li₂S as Active Material and Carbon

A dry complexing process is conducted at a moisture-controlled area because Li₂S is sensitive to moisture.

The Li₂S and a conducting material were subjected to powder complexing. The Li₂S powder is crushed to an average particle diameter of 5 μm and the selected conducting material were filled into a dry-type complexing device at 86:14 wt % Li₂S conducting material.

The process was conducted at 300 RPM for 6 min with a maintaining powder filling amount of 70% or more (step 1). 6 g of additional conducting material and 20 g of a selected binder per 100 g of powder complexed through step 1 were mixed together. 50 g of the mixture was mixed with 60 g of a xylene solvent (step 2). The mixture of step 2 was place into a ball mill and mixed for about 3 hours to obtain a slurry (step 3). The slurry of step 3 was coated on a collector to a set thickness (for example: 20 μm) (step 4). The coated slurry of step 4 was dried with 100° C. hot air (step 5).

The powder complexing process used in step 1 will be described in detail as follows.

Powder complexing was conducted using Nobilta equipment of Hosokawa Micron Corporation, a powder equipment manufacturer. A 40 cc-grade equipment for research, the Nobilta-mini was used.

As raw materials, Li₂S as a mother particle consists of powder having average particle diameter of 5 μm powder, and a carbon daughter particle used as the conducting material was selected from vapor grown carbon fiber (VGCF), a carbon nanotube (CNT), Super C which is a kind of acetylene black, and graphite.

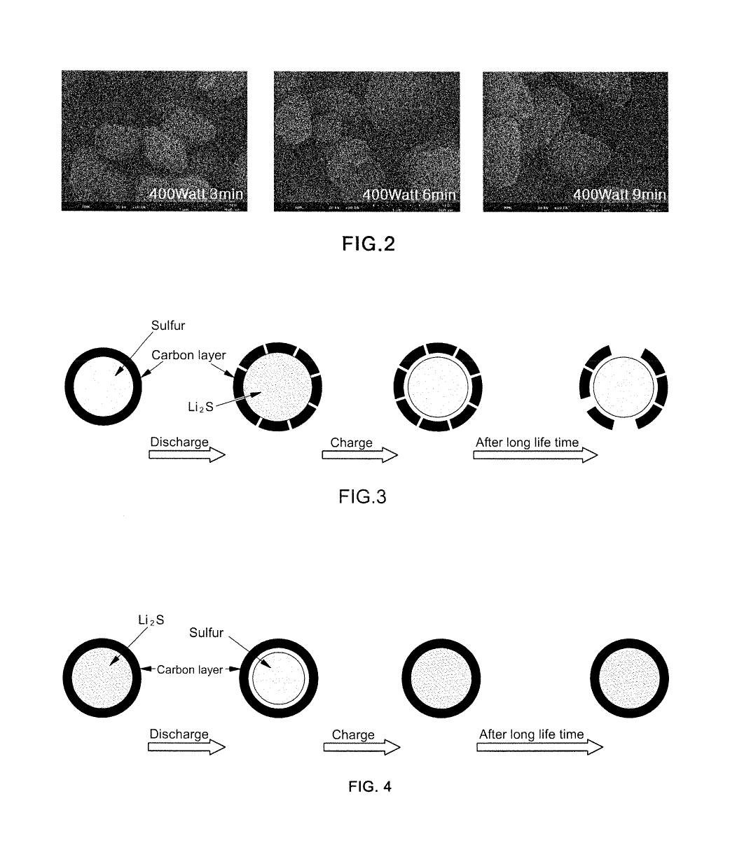

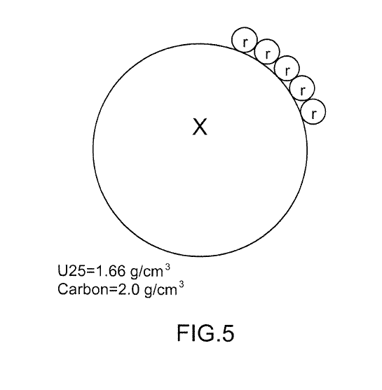

During complexing, the powder shearing force was maintained at 400 W, and the process time was 6 min. Photographs of the complexed Li₂S are shown in FIG. 2 (process time: 3 min, 6 min, and 9 min).

Table 1 shows the conducting materials and binders used in Examples.

TABLE 1

| | Conducting material | Binder |
|---|---|---|
| Example 1 | VGCF | NBR |
| Example 2 | CNT | NBR |
| Example 3 | Super C | NBR |
| Example 4 | Graphite | NBR |
| Example 5 | VGCF | SBR |

Table 2 shows physical properties of the conducting materials used in Examples.

TABLE 2

| | VGCF | CNT | Super C | Graphite |
|---|---|---|---|---|
| Shape | Fiber | Needle | Circle | Plate |
| Size | Diameter: 150 | Diameter: 15 | Diameter: 40 | Diameter: 3 |
| | Length: 15 | Length: 0.5 | | |
| Crystallinity | Crystalline | Amorphous | Amorphous | Crystalline |
| Tap Density | 0.12 | 0.13 | 0.09 | 0.17 |
| (g/cc) | | | | |

### Comparative Example 1

### Manufacturing Cathode Using Sulfur Powder

For manufacturing a sulfur electrode, sulfur powder, a conducting material, (vapor grown carbon fiber; VGCF), and a binder (PVdF) were weighed at weight ratio of 60:20:20 to the total amount of 50 g, and added to 60 g of a solvent (NMP, N-methyl-2-pyrolidone). (Step 1)

After this, steps 3 and 4 of Example 1 were repeated.

### Comparative Example 2

### Manufacturing Cathode Using Li₂S (Without Complexing Process)

Li₂S, a conducting material (vapor grown carbon fiber (VGCF)) and a binder (NBR) were prepared at moisture-controlled area (step 1). The Li₂S, the conducting material (vapor grown carbon fiber; VGCF) and the binder (NBR) were weighed at a weight ratio of 70:15:15 to total amount of 50 g, and added to 60 g of solvent (xylene) (step 2). The mixture of step 2 was placed into a ball mill and mixed for about 3 hours to obtain a slurry (step 3). The slurry of step 3 was coated on a collector to a set thickness (for example, 20 μm) (step 4). The coated slurry of step 4 was dried with 100° C. hot air. (step 5).

As described above, the cathode was completed.

### Experimental Example

### Charge/Discharge Evaluation

A 2032 coin cell was manufactured by using the sulfur cathode manufactured according to the present disclosure, lithium metal anode as a counter electrode, and an electrolyte wherein lithium bis(trifluoromethane sulfonyl)imide (LiTFSi) salt was dissolved in tetraethylene glycol dimethyl ether dioxide (TEGDME/DIOX), and discharge capacity was evaluated by repeating charge/discharge 100 times.

In the cases of the coin cells using the electrodes of the Examples and Comparative Example 2, which were in discharged state right after being manufactured, discharge capacity was tested after charging. In the case of the cell using the electrode of Comparative Example 1, which was in a charged state right after manufacturing, discharge capacity was immediately tested.

TABLE 3

| | Discharge capacity | Discharge capacity | Capacity |
|---|---|---|---|
| | after 1 cycle | after 100 cycles | retention |
| | (mAh/g_s) | (mAh/g_s) | rate (%) |
| Example 1 | 950 | 708 | 75% |
| Example 2 | 980 | 690 | 70% |
| Example 3 | 960 | 710 | 74% |
| Example 4 | 700 | 400 | 57% |
| Example 5 | 960 | 695 | 72% |
| Comparative | 1010 | 480 | 48% |
| Example 1 | | | |
| Comparative | 970 | 502 | 52% |
| Example 2 | | | |

After 100 cycles, the Examples showed a large discharge capacity increase as compared to Comparative Examples.

The initial discharge capacity was relatively lower than Comparative Example 1, but the capacity retention rate was higher. This shows that the life time of the battery is improved.

When comparing performances of Examples, the case of using graphite having large particle size as a conducting material showed poor initial discharge capacity and capacity retention rate.

Consequently, the cathode structure wherein Li₂S powder is complexed and covered with a conducting material maintains the structure, which is fit to the volume expanded active material. Accordingly, the life time of the lithium-sulfur battery is improved by preventing collapse of the cathode structure caused by a volume expansion after repeated charge/discharge cycles.

The lithium-sulfur battery using the cathode structure, which is manufactured by the method of the present disclosure shows improved life time. For example, when comparing capacity retention rates at 1/20 C after the life time test of 100 cycles of a coin cell, the coin cell according to the present disclosure showed a capacity retention rate of about 70-80%, compared to the coin cell using the conventional cathode, which showed capacity of about 50%.

The invention has been described in detail with reference to embodiments thereof. However, it will be appreciated by those skilled in the art that changes may be made in these embodiments without departing from the principles and spirit of the invention, the scope of which is defined in the appended claims and their equivalents.

What is claimed is:

1. A method for manufacturing a cathode of a lithium-sulfur secondary battery, comprising steps of:
1) powder-complexing of Li₂S as a mother particle and a conducting material as a daughter particle;
2) mixing the powder complexed in step 1) and a binder in a solvent to form a mixture, adding additional conducting material to the mixture, and then further mixing the mixture;
3) placing the mixture of step 2) in a ball mill and then mixing the mixture in the ball mill for 0.2-24 hours to obtain a slurry;
4) coating the slurry of step 3) on a collector to a thickness of 0.005-0.2 mm; and
5) drying the coated slurry of step 4) with hot air at a temperature higher than ambient.

2. The method of claim 1, wherein the conducting material is a carbon material.

3. The method of claim 2, wherein the carbon material is a carbon nanotube (CNT), acetylene black, vapor grown carbon fiber (VGCF) or a mixture of at least two thereof.

4. The method of claim 1, wherein the binder is nitrile butadiene rubber (NBR), styrene butadiene rubber (SBR), or a mixture thereof.

5. The method of claim 1, wherein the solvent is an aromatic solvent, selected from toluene, xylene, benzene, C₆-C₂₀ aliphatic solvent, or a mixture of at least two thereof.

6. The method of claim 1, wherein the collector is Al.

7. The method of claim 1, wherein powder complexing of step 1) is conducted through a mechanofusion process.

8. The method of claim 7, wherein an average diameter of Li₂S to be powder complexed in step 1) is 10 times or greater of a diameter of the first conducting material.

9. The method of claim 1, wherein an average particle size of the daughter particle is 1/10 or less of an average particle size of the mother particle.

10. The method of claim 1, wherein the content of the daughter particle to be powder complexed (1/(a+1)) is determined by the following Formulas 1 to 3:
Formula 1
When the number of the daughter particle required for 100% covering a surface of the mother particle having a radius of x and the daughter particle having a radius of r is designated as X,
$$π {r}^{2} X = 4 {π ( x + 2 r )}^{2}$$
$$X = \frac{4 {( x + r )}^{2}}{{r}^{2}}$$
Formula 2
a weight of X of the complexed powder of step 1) having a density
$$( d ) = d \frac{4}{3} π {r}^{3} \frac{4 {( x + r )}^{2}}{{r}^{2}} = \frac{16}{3} d π {r ( x + r )}^{2}$$
Formula 3
a weight of the mother particle/weight of the daughter particle=
$$a = \frac{\frac{4}{3} π {x}^{3} \times 1.66}{\frac{16}{3} d π {r ( x + r )}^{2}} = \frac{1.66 {x}^{3}}{4 d {r ( x + r )}^{2}}$$
.
